(19) United States
(12) Patent Application Publication
(10) Pub. No.: US 2005/0017911 A1
(43) Pub. Date: Jan. 27, 2005

(54) Helmet with built-in antenna

(76) Inventor: Jen-Feng Lee, City of Industry, CA (US)

Correspondence Address: LAW OFFICES OF J.F. LEE, 17800 CASTLETON STREET, SUITE 383, CITY OF INDUSTRY, CA, 91748, US

(21) Appl. No.: 10/624,747

(22) Filed: Jul. 21, 2003

(51) Int. Cl. H01Q 1/12

(52) U.S. Cl. 343/718

(57) ABSTRACT

A helmet with integrated-circuited type antennas built into the top portion of the helmet, so that any SoC (System on Chip) unit such as GPS or cell phone can best utilize the location of the antenna to maximize signal receipt and transmission. Any SoC unit may be fitted to slot(s) located at the inside surface of the helmet, or it can be separately carried by a user on the body, such as around the waist/belt area.

### FIELD OF THE INVENTION

The present invention relates generally to a helmet with built-in antenna for positioning system and optionally for communication. More particularly, the present invention creates a new type of helmet utilizing antennas made from integrated-circuit (IC) technology, as well as antennas for other communication needs such as cell phone. Helmet made pursuant to present invention is greatly suited for search and rescue purposes and helps the rescue workers ease the task of finding locations and engaging in effective communication in remote areas such as deep forest or open wilderness.

### SUMMARY AND OBJECT OF THE INVENTION

Positioning systems such as GPS (Global Positioning Systems) are widely used nowadays. It is not uncommon for mountain climbers, pilots and search and rescue workers to carry GPS systems when out on missions. The GPS systems used by most people have built-in antenna that is part of the GPS system unit. The reception of GPS satellite signal, however, is not optimized due to the fact that the antenna is not mounted on a local high point available to the user. The utility of the GPS used by most people today is thus greatly diminished.

Modern day antennas for GPS are as small as or smaller than a human nail. One or more antennas, such as ceramic patch antennas, can be built into the material forming the top portion of a helmet. Naturally, when a user such as a rescue worker wears a helmet with GPS antenna on top, the signal reception is optimized than otherwise the case.

A metal strand ending with a contact point inside the helmet is provided so that the satellite signal picked up by the antenna can be transmitted by a length of wires running to a GPS system unit for calculation purpose.

Modern day GPS systems are manufactured in the SoC (System On Chip) style. Which means the functionality of a whole GPS system is implemented on a single chip, with a resulting unit the size of one square inch or less, not including the requisite packaging/housing portion, or the display. It is therefore conceivable to create a slot in the inside surface of the helmet to mount the GPS SoC unit which is packaged and sized to fit the slot.

The GPS system unit can optionally be attached to the body of a user, like the way people carry their cell phones on their belts.

A display panel, unlike the antenna and the GPS SoC, cannot be shrunk in size due to the purpose of providing a view plane for human eyes. Present invention thus envision a LCD display panel shaped to conform to the concave inside surface of the helmet, and is mounted in a way to avoid blocking user's view when not in use, and in a way to be easily positioned for viewing GPS information.

Preferred embodiment of the mounting methods are further disclosed in the drawings herein.

Present invention also envisions a communication system, such as a cell phone, to be built into another slot, optionally, so that an ear-piece can be built to the side of the helmet and a mouth-piece can be mounted to the helmet, all utilizing the advantage of the antenna sitting at the top portion of the helmet, providing best reception and transmission of radio and satellite signals.

Use of anti-radiation protective gear/shield can be added to the ear-piece or the helmet material. Present invention, however, does not claim the use of such anti-radiation device.

### BRIEF DESCRIPTION OF THE DRAWINGS

The accompanying drawings, which are incorporated in and constitute a part of this specification, illustrate the preferred embodiment of the invention and together with the description, serve to explain the principles of the invention. A brief description of the drawings is as follows:

FIG. 1 shows two antennas are embedded into the layer of material forming the shape of a helmet. Wires are built into the layer, enabling radio/satellite pickup at three different points. A LCD display panel is shown near the front of the helmet. The LCD display panel, shaped to conform to the curvature of helmet, is bolted to the end portion of the helmet so that it can swing up when no in use, and can swing down to provide a view plane for the person wearing the helmet.

FIG. 2 shows a ear-piece and a mouth-piece can be built into the helmet, with signal wires connecting to a relay point (40) that further transmit/receive to/from the communication SoC such as a cell phone. The cell phone can be fitted into another slot in the helmet; it can also be in the traditional form of being worn around the waist/belt nowadays.

### DETAILED DESCRIPTION OF THE PREFERRED EMBODIMENT

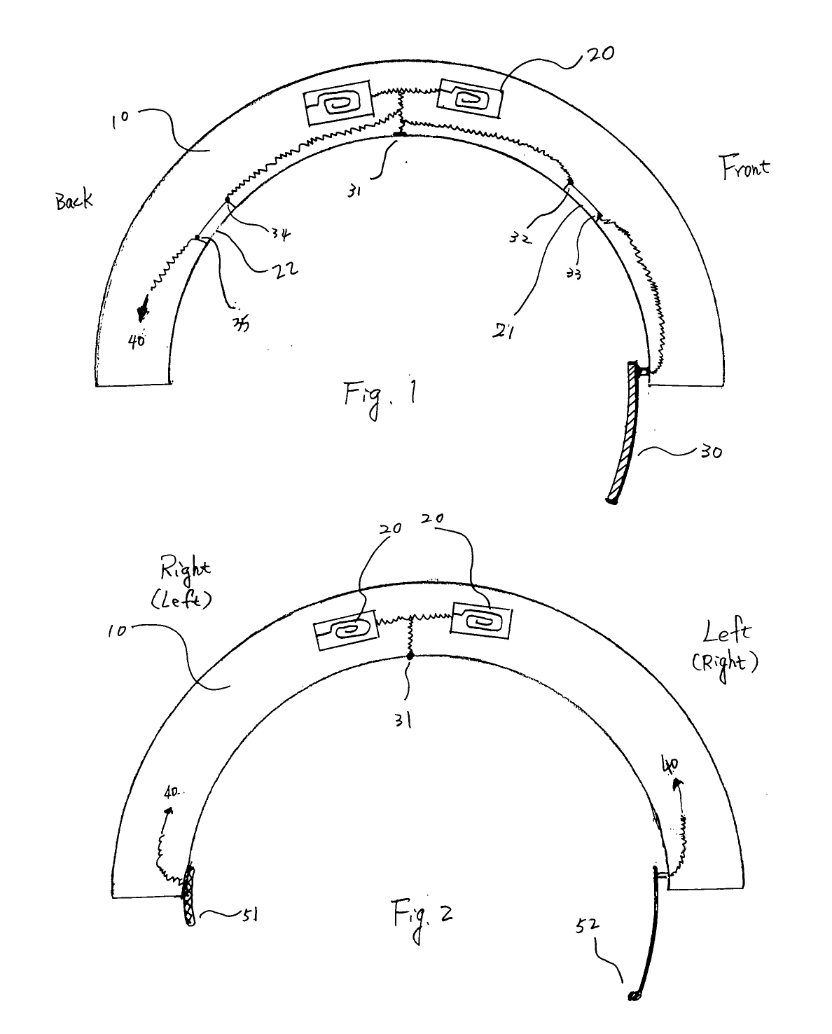

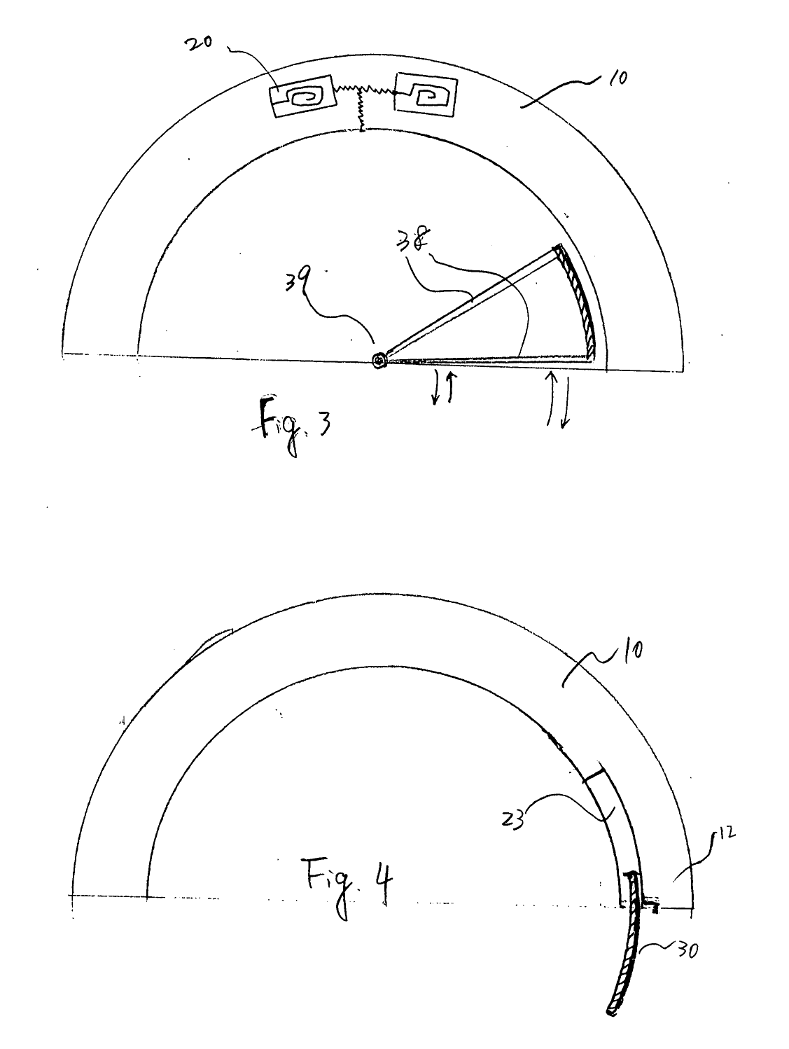

In FIG. 1 and FIG. 2, Two antennas 20 were built into the layer of material 10 forming the helmet. More of antennas 20 can be used, depending on the signal gain desired. Wires are built into the material 10, connecting the antennas 20, and to send the satellite/radio signals going to point 31, 32 and 34, respectively.

Point 31 is a means of metal click-in metal contact for connecting signals to a GPS SoC unit worn, for example, around the waist/belt.

Point 32 is a means of metal click-in metal contact situated inside slot 21, wherein there can be found a GPS SoC unit packaged/housed in a size to fit slot 21.

Point 34 is a means of metal click-in metal contact situated inside slot 22, wherein there can be found a communication unit, such as a cell phone SoC unit, packaged/housed in a size to fit slot 22.

Some length of wires are further built into the material 10, to send signals from the slotted-in GPS SoC in slot 21 to LCD display panel 30, and to transmit/receive signals to/from the relay point 40.

Point 33 is a means of metal click-in metal contact situated inside slot 21, wherein a GPS SoC fitted into slot 21 can send its vedio output signals to LCD panel 30.

Point 35 is a means of metal click-in metal contact situated inside slot 22, wherein a communication unit, such as a cell phone SoC unit, fitted into slot 22 can transmit/receive its signals to and from the relay point 40, which further sends signals to ear-piece 51 and receive signals from mouth-piece 52.

Depending on the ease of implementation by manufacturer and any industry convention, the left/right choice can be reversed in FIG. 2. Putting ear-piece 51 and mouth-piece 52 on the same side can also be done.

LCD display panel 30 utilizes a bolt at one corner of its housing, bolting to the front inside surface of the helmet, so that it can swing up and down. LCD display panel 30 can optionally be mounted to material 10 by sliding means, as illustrated in FIG. 3 and FIG. 4.

FIG. 3 shows that the LCD panel 30 can be mounted to a rack 38 with two bolts on two sides of helmet, so that the rack 38 swings pivotally up and down like a visor. Two pivotal knobs 39 are set near the center of the (half) circle defining the shape of the helmet.

FIG. 4 shows that a groove, or a slot 23 can be utilized to house the LCD display panel 30, which is slidably attached to the left and right side of said groove/slot 23. A Locking pin 12, or other click-in means, can be used to secure display panel 30 into groove 23 when not in use.

1. A helmet with built-in antenna, comprising:
One or a plurality of integrated-circuit antennas built into the layer of material on top portion of said helmet, and
Metal strands connecting said antennas through the layer of said helmet so that signals received from said antennas can be transmitted to a separate electronic means by wires.

2. The helmet of claim 1, wherein said electronic means is a GPS SoC system.

3. The helmet of claim 2, wherein the inside surface of said helmet contains a depressed area defining a slot for receiving a GPS SoC sized to fit the slot.

4. The helmet of claim 3, wherein said GPS SoC can optionally be carried or mounted on the body of the person wearing said helmet, and connected to said antennas by a length of wires to said metal strands at the inside surface of said helmet.

5. The helmet of claim 3 or 4, further comprising a LCD display panel so shaped to conform to the inside curvature of said helmet, and rotatably mounted to the inside surface of said helmet to display positioning information sent from said positioning means, so that said LCD could be rotated down for use and rotated up to avoid blocking user's view when not in use.

6. The helmet of claim 3 or 4, further comprising a LCD display panel so shaped to conform to the inside curvature of said helmet, and slidably mounted to the inside surface of said helmet to display positioning information sent from said positioning means, so that said LCD could be slid down for use and slid up to avoid blocking user's view when not in use.

7. The helmet of claim 1, wherein said separate electronic means is a cell phone SoC mounted to a slot on the inside surface of said helmet, with ear-piece so positioned as to be close to wearer's ear, and a mouth-piece rotatably mounted to enable rotating up and down for ease of use.
